(19) United States
(12) Patent Application Publication
(10) Pub. No.: US 2025/0170962 A1
(43) Pub. Date: May 29, 2025

(54) Providing a Surroundings Display on Board a Motor Vehicle

(71) Applicant: Bayerische Motoren Werke Aktiengesellschaft, Muenchen (DE)

(72) Inventors: Fabian FRANKE, Muenchen (DE); Philipp HOFFMANN, Hannover (DE); Thomas KRINNER, Gaissach (DE)

(21) Appl. No.: 18/923,797

(22) Filed: Oct. 23, 2024

(30) Foreign Application Priority Data
Nov. 23, 2023 (DE) 10 2023 132 725.9

(51) Int. Cl. B60R 1/26

(52) U.S. Cl. CPC B60R 1/26; B60R 2300/105; B60R 2300/205; B60R 2300/303; B60R 2300/306; B60R 2300/8046

(57) ABSTRACT

A method for providing a surroundings display on board a motor vehicle includes creating a first image of a first area located behind the motor vehicle; creating a second image of a second area located behind the motor vehicle, wherein an image angle of the first image is greater than an image angle of the second image; and editing the second image into the first image and providing a resulting third image.

### CROSS REFERENCE TO RELATED APPLICATION

This application claims priority under 35 U.S.C. § 119 from German Patent Application No. DE 10 2023 132 725.9, filed Nov. 23, 2023, the entire disclosure of which is herein expressly incorporated by reference.

### BACKGROUND AND SUMMARY

The present invention relates to providing a surroundings display on board a motor vehicle. In particular, the invention relates to a camera-monitor system.

A motor vehicle comprises a camera-monitor system (CMS), which is configured to replace a traditional rearview mirror. The CMS comprises a camera, which is configured to scan an area of the surroundings located behind the motor vehicle, and a monitor for displaying an acquired camera image. Attachment locations of the camera and the monitor are preferably matched to one another in order to provide a similar optical impression to a driver of the motor vehicle to that of a rearview mirror.

To replace a side view mirror, a camera can be arranged laterally on the motor vehicle, wherein the monitor is preferably attached on the same vehicle side. To replace an interior mirror, a camera can be provided which is arranged in the middle in the transverse direction of the vehicle. An associated monitor can also be arranged in the middle. In one embodiment, two CMS can also be combined with one another in that the same monitor is used for both cameras. This monitor is typically attached in a central console, which is located between a driver and a front passenger. However, such a central monitor can be substantially or completely utilized by the display of two camera images. The operation of another device, such as an air conditioning system or an entertainment system, can then no longer be possible. In another embodiment, a camera image only occupies a part of the monitor, wherein only one camera image of either one or the other camera can be displayed.

Different views of the surroundings can be required in different driving states of the motor vehicle. One object underlying the present invention is to provide improved technology for displaying the surroundings of a motor vehicle by way of a camera mirror system. The invention achieves this object by way of the subjects of the claimed invention.

According to a first aspect of the present invention, a method for providing a surroundings display on board a motor vehicle comprises steps of creating a first image of an area located behind the motor vehicle; creating a second image of an area located behind the motor vehicle, wherein an image angle of the first image is greater than an image angle of the second image; and editing the second image in the first image; and providing a resulting third image.

It has been recognized that different cameras on a motor vehicle have different image angles, wherein the camera having the smaller image angle provides an image which represents a part of an image of the other camera having the larger image angle. The second image can thus be edited in the first to produce the third image. A transition between the first and the second image can be designed here so that no or only very minor geometric distortions, missing image contents, or jumps are perceptible in the display. A technology which is known under the name stitching can be used for editing the second image in the first image.

The third image can be provided to a driver of the motor vehicle. The third image can be displayed on a single monitor which displays contents of both cameras simultaneously.

Geometries of the first and the second image are preferably adapted to one another for the third image. For this purpose, the selection of an image detail, a size, or a distortion can be adapted. In different embodiments, the geometry of the first image can be adapted to the geometry of the second or vice versa. Geometries of both images can also be adapted to a higher-order geometry. In a further embodiment, brightnesses or color ranges of the two images can also be adapted to one another.

It is preferred in this case for parameters of the adaptation to be permanently predetermined. A parameter can be predetermined on the basis of properties of a camera which provides the first or the second image. An attachment location of a camera on the motor vehicle, an orientation or an image angle or a focal length can be presumed to be known in this case. These properties of a camera are typically unchanging. The adaptation of the images to one another on the basis of predetermined geometric information can be designated as a pre-warp. An analysis of the image content may not be necessary for the geometric adaptation in this case. The geometric adaptation can be carried out quickly and precisely. Processing resources to be applied can be modest.

In one particularly preferred embodiment, the third image is magnified by a predetermined magnification factor and trimmed to a predetermined dimension. The predetermined dimension can in particular correspond to a display area, which is available for the third image on a monitor.

The magnification factor can now be freely selected so that a detail of the third image can be displayed on the predetermined display area which is selected depending on the magnification factor. If the magnification factor is changed, the impression of a camera movement or a change of the focal length of an underlying camera can thus result on the display. The effect is known under the name zooming in or zooming out. The greater the selected magnification factor is, the more strongly the third image can be influenced or represented by the second image. If the selected magnification factor is small, an emphasis of the second image can be reduced.

It is further preferably possible to animate a change of the magnification factor. In one embodiment of the method, a change of the magnification factor is determined and the magnification of the third image is successively tracked to the magnification factor. For this purpose, a series of third images having different magnification factors can be provided. The magnification of the third image is preferably tracked in such a way that a perceptible effect of zooming in or zooming out results for an observer. In one embodiment, sufficiently many third images are displayed so that a continuous animation results for the observer.

The magnification can be tracked at a predetermined speed. The predetermined speed can be constant or can follow a predetermined curve. In a further embodiment, the magnification follows a predetermined speed profile. The predetermined profile can in particular represent a slow change at the beginning and/or at the end of the animation and a faster change in between. Switching between different views which are characterized by different magnification factors can be intuitive for the observer. A view of the surroundings can be provided continuously to the observer and the view can be adapted depending on applicable circumstances by corresponding selection of the magnification factor.

In one particularly preferred embodiment, a first and a second magnification factor are predetermined. The speed profile can be applied between the magnification factors. The first magnification factor can be assigned to a first representation and the second magnification factor can be assigned to a second representation.

One of the predetermined magnification factors can be selected depending on a signal which indicates whether the motor vehicle is to drive forward or in reverse. The signal can be provided in particular by a transmission which can switch between forward and reverse driving. The signal can also be provided by an operating element for such a transmission. In an automatic transmission, forward driving can be expressed by the drive position D and reverse travel can be expressed by the drive position R. In a manual shift transmission, multiple forward gears and one or more reverse gears can be manually engaged.

If the motor vehicle is to drive in reverse, a small magnification factor can thus be selected, so that an image angle of the displayed third image is large and an observer has a good overview of an area located behind the motor vehicle. If the motor vehicle is to drive forwards, the selected magnification factor can thus be higher, so that the observer has the third image presented with a smaller image angle. Adapted views can thus be displayed on a single monitor in each case for forward and reverse driving. Transitions between the displays can be animated, so that the motor vehicle can be controlled in an improved manner depending on the display of the third image.

According to a further aspect of the present invention, a device for providing a surroundings display on board a motor vehicle comprises a first camera for providing a first image of an area located behind the motor vehicle; a second camera for providing a second image of an area located behind the motor vehicle; wherein an image angle of the first image is greater than an image angle of the second image; and a processing device, which is configured to edit the second image in the first image and to display a resulting third image.

The processing device is preferably configured to partially or completely carry out a method described herein. For this purpose, the processing device can be embodied as electronic and can comprise, for example, an integrated circuit, a programmable logic component, or a programmable microcomputer. The method can be implemented in the form of a configuration or as a computer program product having program code for the processing device. The configuration or the computer program product can be stored on a computer-readable data carrier. Features or advantages of the method can be transferred to the device or vice versa.

The device can comprise a display device for displaying the third image to a driver of the motor vehicle. The display device is preferably attached in front of the driver, so that the driver can register an area of the surroundings of the motor vehicle located behind them on the display device.

The display device can be characterized in that it is significantly wider than it is tall. In one embodiment, a ratio of a width to a height of the third image on the display device is greater than four. The ratio can also be greater than five or more preferably greater than six. In a further embodiment, the ratio can be twelve or more.

For example, the display device can comprise a head-up display. The display device can be represented by way of projection technology on board the motor vehicle. It is possible here that a display area of the display device occupies practically the entire width of an interior of the motor vehicle. A height of the display area can accordingly be significantly less. For example, a projection can take place on the lower edge of a windshield. Such a display is known as a panorama head-up display.

According to still another aspect of the present invention, a motor vehicle comprises a device described herein. The motor vehicle preferably comprises a passenger vehicle. In further embodiments, the motor vehicle can also comprise, for example, a truck or a bus.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system.

FIG. 2 illustrates a flow chart of a method.

FIG. 3 illustrates an exemplary edit of a second image in a first image.

FIG. 4 illustrates an exemplary view of a third image on a display device on board a motor vehicle.

### DETAILED DESCRIPTION OF THE DRAWINGS

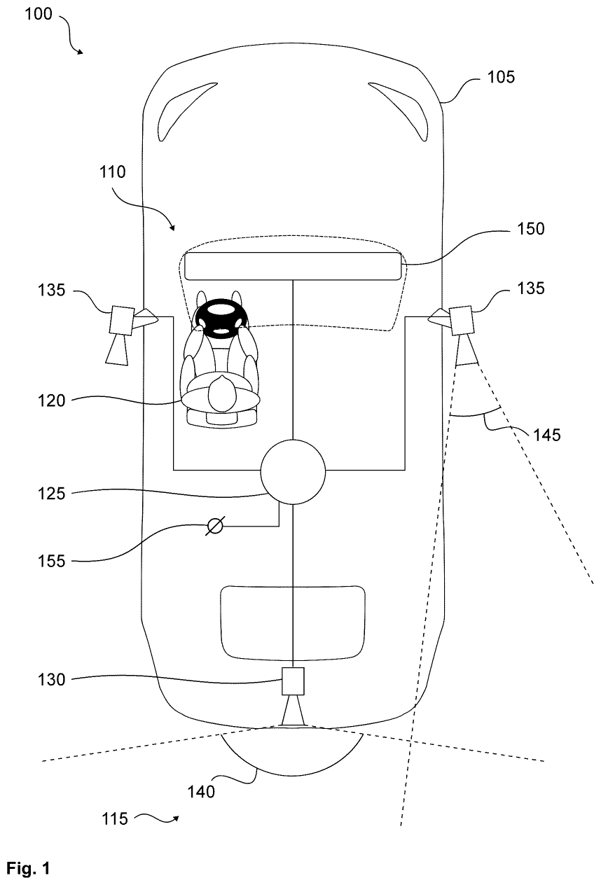

FIG. 1 shows a system 100 having a motor vehicle 105, which comprises a device 110. The device 110 is configured to scan a section of the surroundings 115 of the motor vehicle 105 and display it in the motor vehicle 105. The display is directed in particular to a person 120, who can be a driver of the motor vehicle 105. Solely by way of example, the person 120 is shown on a left vehicle side in FIG. 1.

The device 110 comprises a processing device 125, a first camera 130, and a second camera 135. The first camera 130 can in particular comprise a reversing camera, which is furthermore preferably attached in the middle on the motor vehicle 105 in the transverse direction. The second camera 135 can comprise a side camera, which can be attached on a right or left side of the motor vehicle 105. In the longitudinal direction, the second camera 135 can be attached as shown approximately at the level of a first row of seats. In another embodiment, the second camera 135 can also be displaced in the longitudinal direction, in particular to the rear. In the illustration of FIG. 1, two second cameras 135 are shown on sides opposite to one another.

The first camera 130 operates with a first image angle 140 and the second camera 135 with a second image angle 145. The first image angle 140 is greater than the second image angle 145 here. The first image angle 140 can be, for example, in the range of approximately 180°. The second image angle 145 is typically approximately 60° or less. Scanning areas of the cameras 130, 135 overlap in particular in an area behind the motor vehicle 105.

The device 110 can furthermore comprise a display device 150, which is embodied by way of example as a projection surface of a panorama head-up display (pHUD). An optional interface 155 is configured to acquire a signal, which indicates whether the motor vehicle 105 is to drive forward or in reverse. The interface 155 can be connected, for example, by way of a data bus to a transmission, an operating unit, or a control unit for a transmission. The signal is preferably bivalent, wherein one value is assigned to forward driving and another to reverse driving. A corresponding signal can be used to actuate a reversing headlight of the motor vehicle 105.

The processing device 125 is configured to edit an image provided by a second camera 135 into an image provided by the first camera 130. Depending on a magnification factor, which can be selected on the basis of the signal determined at the interface 155, the resulting image can be scaled and trimmed to a predetermined dimension. The result of the processing can be displayed on the display device 150 or a section thereof.

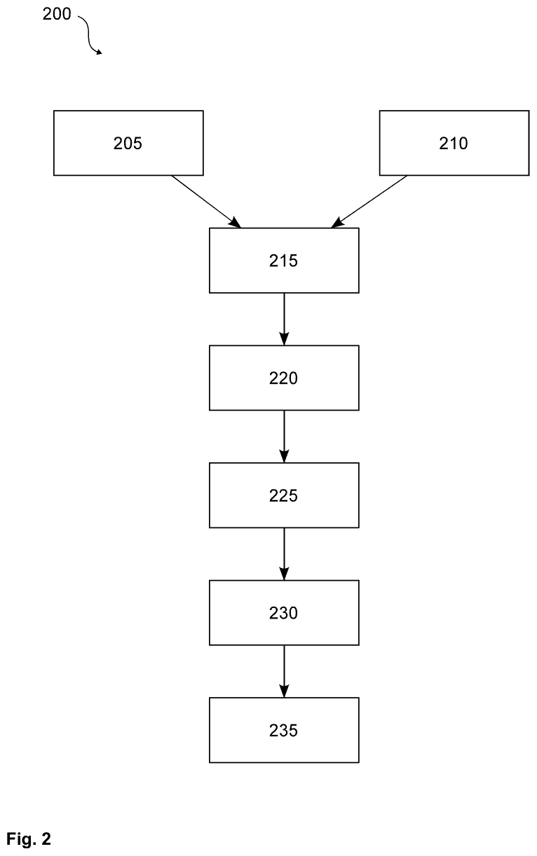

FIG. 2 shows a flow chart of a method 200 for displaying the surroundings 115 on board a motor vehicle 105. In a step 205, a first image is provided at a first image angle 140. In particular the first camera 130 can be used for this purpose. In a step 210, a second image is provided at a second image angle 145, which is less than the first image angle 140. The second image is preferably acquired by way of a second camera 135.

In a step 215, the second image is edited into the first image. Due to the smaller image angle, the second image only shows a detail of the first image. The second image is edited into the first image in such a way that transitions between the first and the second image are as inconspicuous as possible. For this purpose, the first image and/or the second image can be distorted or rectified appropriately. Furthermore, color matching or brightness matching can take place. A third image results from the editing.

In a step 220, a direction of travel can be determined, in which the motor vehicle 105 is to drive. The direction of travel can in particular be forward or reverse. On the basis of the direction of travel, a magnification factor can be determined in a step 225. A magnification factor can be assigned to a direction of travel. The magnification factor which is assigned to reverse travel is preferably less than the magnification factor which is assigned to forward travel.

In a step 230, the third image can be scaled using the determined magnification factor. During a change of the magnification factor, an animation can be created for this purpose in which the third image is scaled with a series of monotonously decreasing or monotonously increasing magnification factors. A change of the magnification factor over time can be determined according to a predetermined transition. A duration of the transition is preferably predetermined and can be in a range from a few seconds to less than one second. The scaled third image can be provided in a step 235. In particular, the third image can be output on the display device 150 to a person 120 on board the motor vehicle 105.

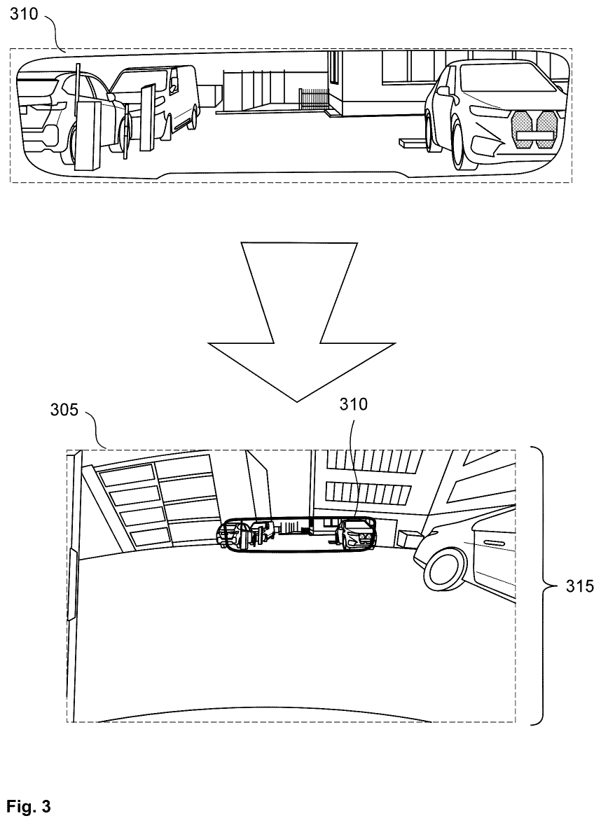

FIG. 3 shows an exemplary edit of images. A first image 305, which is recorded by a reversing camera 130 of a motor vehicle 105, is shown in a lower area. A second image 310, which can have been recorded by a side camera 135 on the same motor vehicle 105, is shown in an upper area.

The second image 310 is inserted in scaled form at the matching point into the first image 305, so that a third image 315 results. The third image 315 can now be subjected to a predetermined magnification factor in order to display a detail in enlarged form. A vanishing point of the magnification is preferably predetermined and is preferably in the area of the second image 310 within the third image 315. The magnification factor can be increased until the display exclusively shows the second image 310. Optionally, the display can be magnified further until only a detail of the second image 310 is still visible.

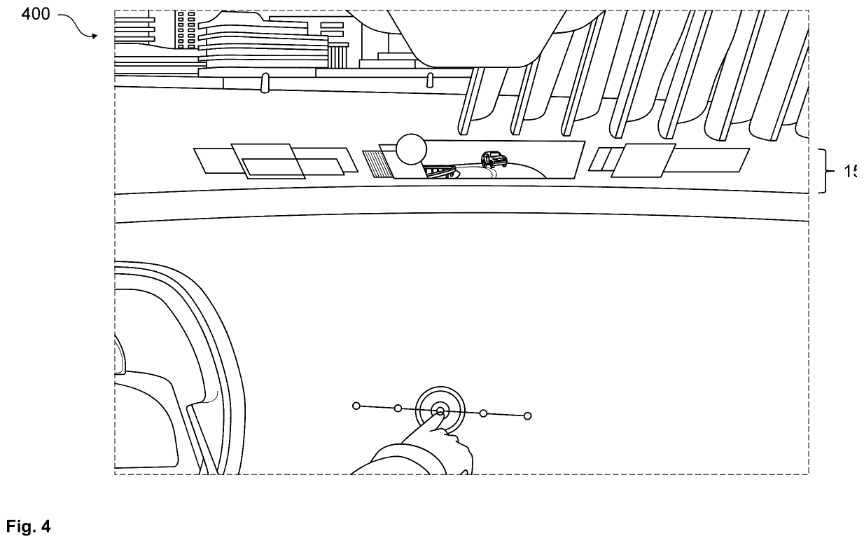

FIG. 4 shows an exemplary view 400 of a third image 315 on a display device 150 on board a motor vehicle 105. The display is based on a perspective which a front passenger in the first row of seats of the motor vehicle 105 could assume, for example. A dashboard of the motor vehicle 105 is shown in a lower area, which is adjacent at its upper end to a windshield of the motor vehicle 105. In a left area, the dashboard is partially concealed by a steering wheel, using which the motor vehicle 105 can be controlled.

The display device 150 is embodied as a pHUD, wherein a wide strip, which is only a few centimeters tall, however, at the lower end of the windshield is used as the projection surface. A third image 315 can be seen by way of example in a middle area of the projection surface. A view through the windshield of the motor vehicle 105 is possible above the projection surface.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

100 system
105 motor vehicle
110 device
115 surroundings
120 person
125 processing device
130 first camera, reversing camera
135 second camera, side camera
140 first image angle
145 second image angle
150 display device
155 interface
200 method
205 provide first image
210 provide second image
215 stitching
220 determine direction of travel
225 determine magnification factor
230 animate transition
235 output image
305 first image
310 second image
315 third image
400 view

What is claimed is:

1. A method for providing a surroundings display on board a motor vehicle, the method comprising:
creating a first image of a first area located behind the motor vehicle;
creating a second image of a second area located behind the motor vehicle, wherein a first image angle of the first image is greater than a second image angle of the second image; and
editing the second image into the first image and providing a resulting third image.

2. The method according to claim 1, wherein geometries of the first image and the second image are adapted to one another for the third image.

3. The method according to claim 2, wherein parameters of the adaptation are permanently predetermined.

4. The method according to claim 1, wherein the third image is magnified by a predetermined magnification factor and trimmed to a predetermined dimension.

5. The method according to claim 4, wherein a change of the magnification factor is determined and the magnification of the third image is successively tracked to the magnification factor.

6. The method according to claim 5, wherein the magnification is tracked using a predetermined speed.

7. The method according to claim 5, wherein the magnification is tracked using a predetermined speed profile.

8. The method according to claim 5, wherein a first magnification factor and a second magnification factor are predetermined.

9. The method according to claim 8, wherein one of the predetermined magnification factors is selected depending on a signal which indicates whether the motor vehicle is to drive forward or in reverse.

10. A device for providing a surroundings display on board a motor vehicle, the device comprising:
a first camera for providing a first image of a first area located behind the motor vehicle;
a second camera for providing a second image of a second area located behind the motor vehicle, wherein a first image angle of the first image is greater than a second image angle of the second image; and
a processing device, which is configured to edit the second image into the first image and to provide a resulting third image.

11. The device according to claim 10, further comprising a display device for displaying the third image to a driver of the motor vehicle.

12. The device according to claim 11, wherein a ratio of a width to a height of the third image on the display device exceeds four.

13. The device according to claim 11, wherein the display device comprises a head-up display.

14. A motor vehicle comprising the device according to claim 10.
